(19) United States
(12) Patent Application Publication
(10) Pub. No.: US 2003/0088764 A1
(43) Pub. Date: May 8, 2003

(54) Method of supporting multiple PDA systems on a notebook PC

(76) Inventors: Say-Ling Wen, Taipei (TW); Chaucer Chiu, Taipei (TW)

Correspondence Address: BIRCH STEWART KOLASCH & BIRCH, PO BOX 747, FALLS CHURCH, VA, 22040-0747, US

(21) Appl. No.: 09/985,560

(22) Filed: Nov. 5, 2001

(51) Int. Cl. G06F 15/177

(52) U.S. Cl. 713/2; 713/1

(57) ABSTRACT

A method of supporting multiple PDA systems on a notebook PC is disclosed. The method includes the steps of: making two basic partitions for Windows and the PDA on the HD of a notebook PC; providing the options of using the Windows system or the PDA system for a user to select when the notebook PC is turned on; initializing and testing the Windows system and running the Windows OS when the user selects the Windows system; initializing and testing the PDA system and running the PDA OS when the user selects the PDA system.

### BACKGROUND OF THE INVENTION

1. Field of the Invention

The invention relates to a utility and, in particular, to an application method used with notebook PCs for supporting multiple PDA (Personal Digital Assistant) systems (including the OS's (Operating Systems) of hand held PC's, pocket PC's and other small electronic devices).

2. Related Art

With the increase in computer popularity, people often need to use computers to solve problems either at work or at home. In general, two major methods of obtaining information are: (1) from books, newspapers, journals, CD-ROM's, etc; and (2) from the network. However, both of these methods have drawbacks. The information obtained using the first method will become outdated as time progresses. Rapid exchange of information greatly shortens the life cycle of information. However, such information recorded in media like books cannot be easily updated. The information obtained using the second method, however, continuously changes along with the developing world, also resulting in some troubles for users. One can see the problems from the following points:

1. Existing personal computer OS's, such as Windows 98, Windows 2000, Windows XP, Linux, and so on, are complicated despite (or because of) their powerful functions and designs. Moreover, the user operation designs are not intuitive and simple enough. This situation scares people without any computer background because of the obstacles they meet while using these systems.

2. Users who do not understand the network structure do not know where to start their searches. In this case, the user often chooses to use a familiar OS or to install several different OS's in the computer hardware platform. This type of system is called a dual-OS or a multi-OS. However, this method cannot solve the above problems because a utility is needed to switch between the OS's.

3. PDA's are becoming more and more popular. They have properties complementary to the desktop Windows OS, e.g. smaller volume, faster power on, more compact functions, and more convenient to use. Therefore, a method of supporting multiple PDA systems on a notebook PC is an important subject under study. The user is then able to enjoy the functions of different PDA systems on the same notebook PC.

### SUMMARY OF THE INVENTION

In view of the foregoing, the invention provides a method of supporting multiple PDA (Personal Digital Assistant) systems (including the OS's of hand held PC's, pocket PC's and other small electronic devices, but hereinafter referred as PDA as a whole) on notebook PCs. This method is built on the property of coexisting one-touch-PDA OS's and the Windows OS. A main object of the invention is to provide a method to install several PDA systems on the same notebook PC so that the user is not only able to utilize the OS on the notebook PC but can also install several PDA systems. Another object of the invention is to use a finite number of keys as hot keys for the operation of various functions. Therefore, each function can be achieved with one key, allowing for simple and intuitive operation. This will eventually increase users' interest in using PDA's.

The user then switches between the Windows OS and the PDA OS's according to his or her needs.

### BRIEF DESCRIPTION OF THE DRAWINGS

The present invention will become more fully understood from the detailed description given hereinbelow. However, the following description is for purposes of illustration only, and thus is not limitative of the invention, wherein:

FIG. 1 shows a structure of the invention;

FIG. 2 is a schematic view of partitions on an HD of the invention;

FIGS. 3 to 5 show flowcharts of the disclosed BIOS starting a notebook PC and several PDA's; and

FIGS. 6 and 7 show flowcharts of the disclosed BIOS starting several PDA's.

### DETAILED DESCRIPTION OF THE INVENTION

The notebook PC's mentioned in the invention have at least two OS's. Since the PDA system has a small volume and uses few resources, the user can obtain fast and highly efficient functions at a relatively small expense. In particular, the PDA system does no harm to the original Windows OS.

The one-touch-PDA OS is mainly designed for users who do not need to deeply understand the PDA. It provides a simple and intuitive UOI (User Operating Interface) OS that coexists with the existing system. Therefore, several PDA's can be mounted on the same computer hardware platform. This type of multi-PDA can be selectively used as the user wishes.

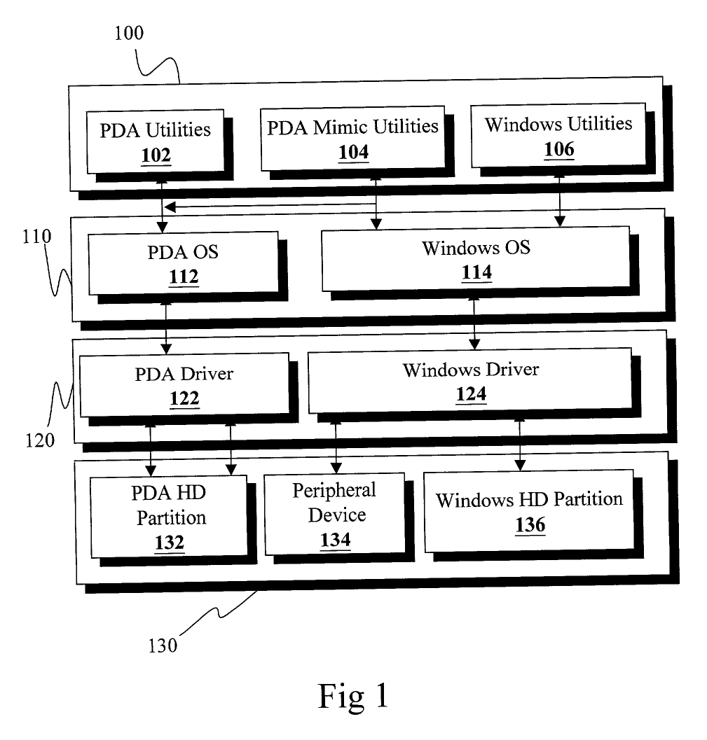

With reference to FIG. 1, the disclosed system includes utilities 100, OS's 110, drivers 120, and a hardware part 130. The utilities 100 include PDA utilities 102, PDA mimic utilities 104, and Windows utilities 106. The OS's 110 include a PDA OS 112 and the Windows OS 114. The drivers 120 include PDA drivers 122 and Windows drivers 124. The hardware part 130 includes a PDA HD (Hard Drive) partition 132, peripheral devices 134, and a Windows HD partition 136.

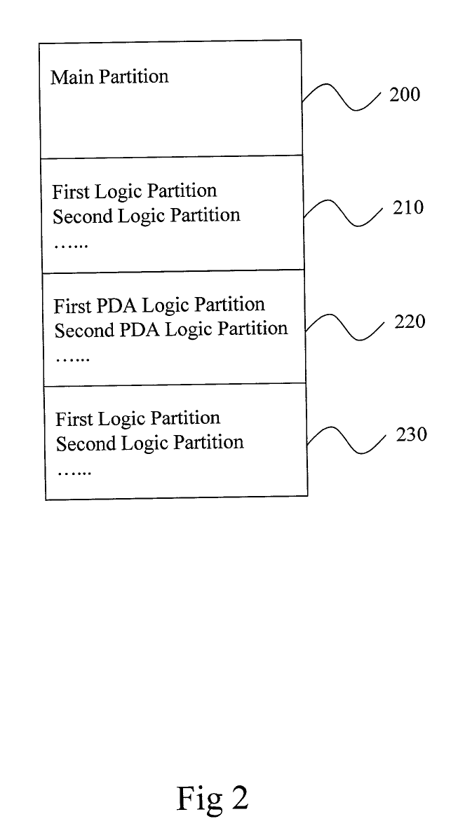

As shown in FIG. 2, the HD partition includes a main partition 200, an extended partition 210, a multi-PDA partition 220, and a second extended partition 230. Several PDA systems can be installed in the multi-PDA partition 220, with each PDA system occupying a logic partition in the multi-PDA partition 220. That is, the disclosed method is to create two basic partitions for Windows (the main partition 200) and PDA (the multi-PDA partition 220). The Windows OS (Windows 98/Windows 2000/Windows XP) is installed in the Windows partition, which is further divided into a first logic partition, a second logic partition, etc. At least one PDA OS and its utilities is installed in the multi-PDA partition, which also has a first logic partition, a second logic partition, etc.

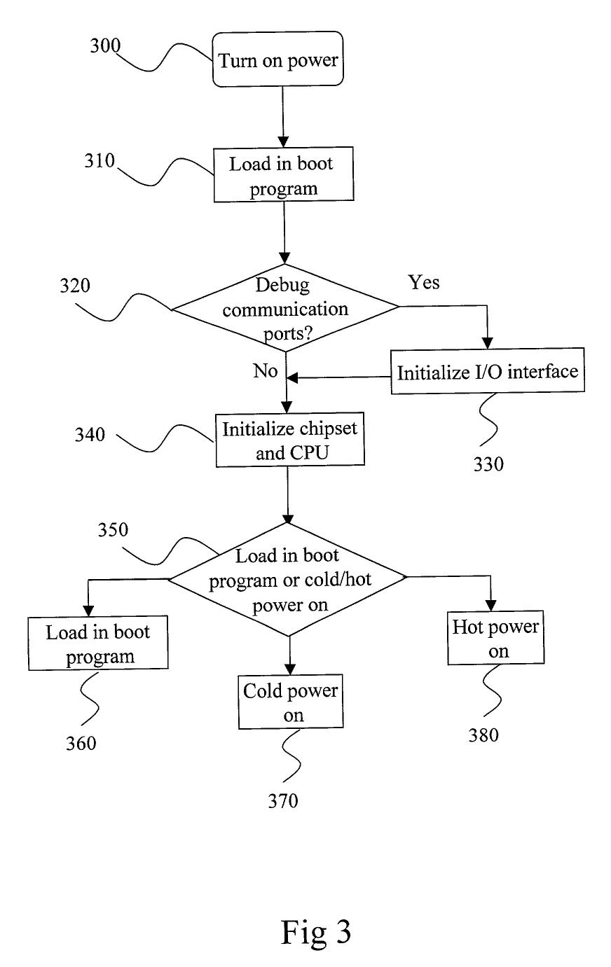

With reference to FIG. 3, after the power of the notebook PC is turned on (step 300), a boot program is loaded (step 310). Step 320 determines whether communication ports need debugging. If debugging is necessary, then the I/O (Input/Output) interface is initialized (step 330); otherwise, the chipset and CPU (Central Processing Unit) are initialized (step 340). Step 350 then provides the options of loading the boot program or cold/hot power on so as to perform boot program loading (step 360), cold power on (step 370) or hot power on (step 380).

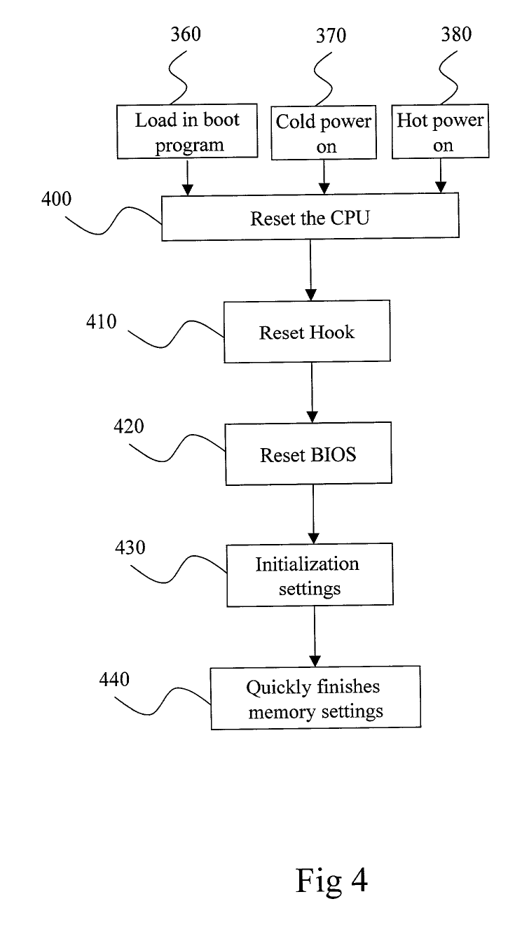

As shown in FIG. 4, after loading in the boot program (step 360), cold power on (step 370) or hot power on (step 380), the system resets the CPU (step 400), the Hook (step 410), and the BIOS (step 420), performs initialization settings (step 430), and quickly finishes memory settings (step 440).

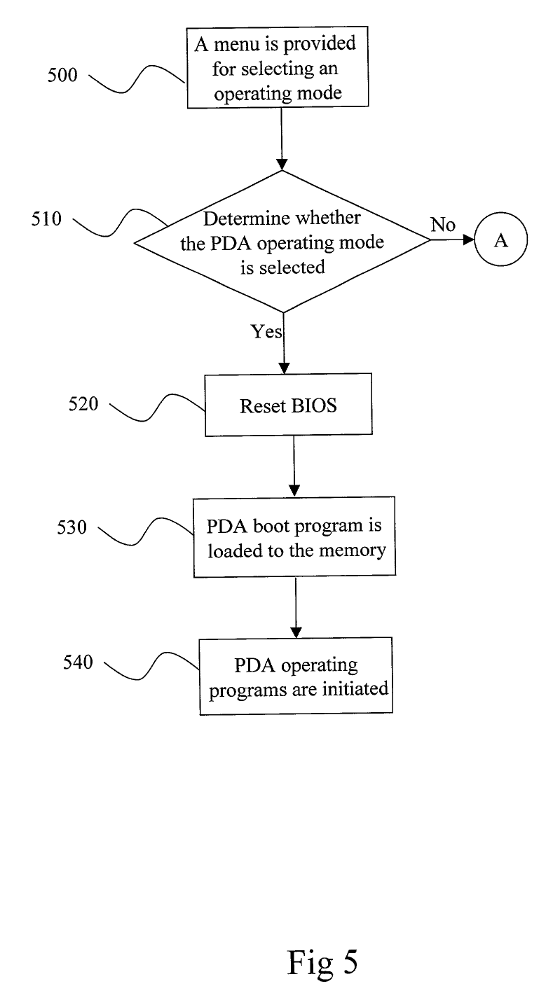

As shown in FIG. 5, a menu is provided for selecting an operating mode (step 500). Step 510 then determines whether the PDA operating mode is selected. If the PDA operating mode is not selected, then step A is executed. Otherwise, the CPU is reset (step 520) and the PDA boot program is loaded to the memory (step 530). Finally, the PDA operating programs are initiated (step 540).

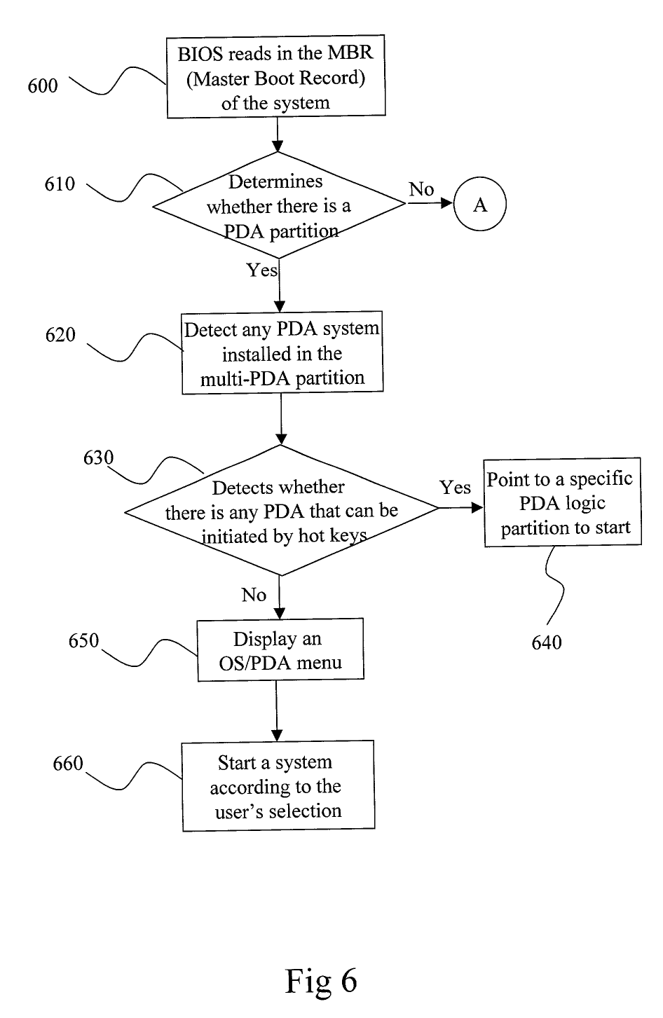

With reference to FIG. 6, the BIOS reads in the MBR (Master Boot Record) of the system (step 600). Step 610 determines whether there is a PDA partition. If no PDA partition exists, then step A is executed; otherwise, the system detects any PDA system installed in the multi-PDA partition (step 620). Step 630 further detects whether there is any PDA that can be initiated by hot keys. If there is, then the system points to a specific PDA logic partition to start (step 640). Otherwise, the system displays an OS/PDA menu (step 650) and starts a system according to the user's selection (step 660).

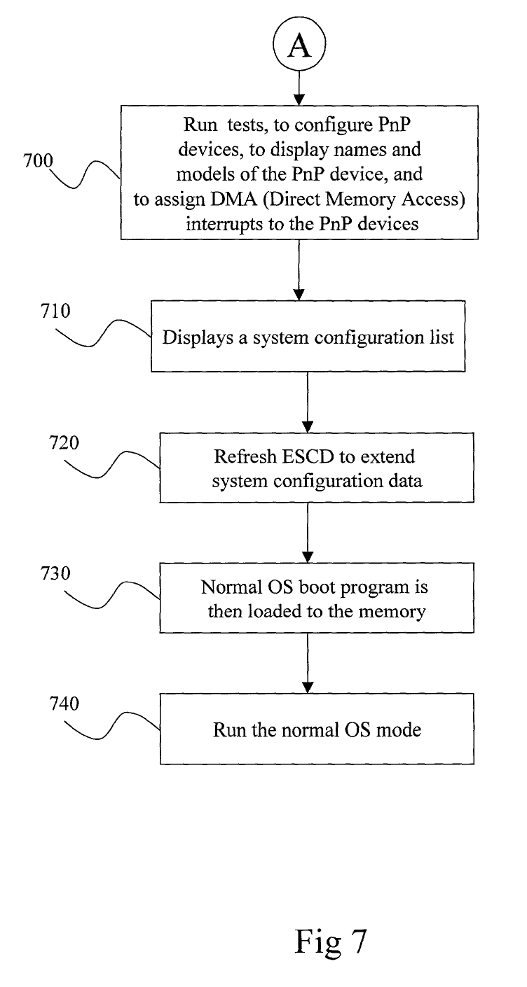

As shown in FIG. 7, without running the PDA OS, step A is performed to run tests, to configure PnP devices, to display names and models of the PnP device, and to assign DMA (Direct Memory Access) interrupts to the PnP devices (step 700). Step 710 displays a system configuration list. Step 720 refreshes ESCD (Extended System Configuration Data) to extend system configuration data. The normal OS boot program is then loaded to the memory (step 730). Step 740 then runs the normal OS mode.

In addition to the above procedures, the invention further provides a PDA key on the notebook PC. After the notebook PC is turned on, the user can press the PDA key for the system to quickly enter the PDA system. Most of the application programs in the PDA system can be run on the notebook PC in the same way as in the PDA environment.

Furthermore, after the notebook PC is turned on, the system quickly enters a coexist (I don't understand the meaning of “coexist” here) PDA menu. Once number keys are selected to enter, the user can use the PDA functions in the notebook PC resources. Otherwise, the notebook PC enters the usual Windows OS.

The invention also provides a PDA mimic utilities for the Windows system. After installing the PDA-mimic utilities, the PDA utilities can be executed in the Windows environment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of implementing multiple PDA (Personal Digital Assistant) system support in a notebook PC, comprising the steps of:
dividing an HD (Hard Drive) of the notebook PC into Windows and PDA basic partitions;
providing options of the Windows system and the PDA system for the user to select after the notebook PC is turned on;
performing the Windows system initialization and test procedures and running the Windows OS (Operating System) when the user selects the Windows system; and
performing the PDA system initialization and test procedures and running the PDA OS when the user selects the PDA system.

2. The method of claim 1, wherein the PDA partition further includes more than one PDA systems.

3. The method of claim 1 further comprising a PDA mimic utility that can switch to the PDA OS from the Windows OS.

4. The method of claim 1, when the PDA OS is selected, further comprising the steps of:
the BIOS's reading an MBR (Master Boot Record) of the system;
making sure that the PDA partition exists;
detecting the PDA systems installed in the PDA partition; and
starting a PDA system according to the user's choice.

5. The method of claim 4 further comprising a menu for the user to select a desired OS to be used.

6. The method of claim 4 further comprising a PDA key for the user to select the PDA operating mode.

7. The method of claim 1, when the Windows OS is selected, further comprising the steps of:
performing tests, configuring PnP devices, displaying names and models of the PnP devices, and assigning DMA (Direct Memory Access) interrupts to the PnP devices;
displaying a system configuration list;
refreshing ESCD (Extended System Configuration Data) to extend system configuration data;
loading the Windows OS boot program to the memory; and
running the Windows OS mode.
